(19) United States
(12) Patent Application Publication
(10) Pub. No.: US 2005/0132191 A1
(43) Pub. Date: Jun. 16, 2005

(54) Method for authenticating different rendering devices with different service providers

(76) Inventors: Ajit P. Joshi, Portland, OR (US); Yevgeniy Epshteyn, Hillsboro, OR (US); Kenneth L. Knowlson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/738,682

(22) Filed: Dec. 16, 2003

(51) Int. Cl. H04L 9/00

(52) U.S. Cl. 713/168

(57) ABSTRACT

A method for authenticating different rendering devices with different service providers and/or different servers in a network. A controlling device identifies a tuner associated with a rendering device. The tuner includes a unique identification. The rendering device is registered with the controlling device. Registration includes storing the rendering device identification and storing the capabilities of the rendering device. At the completion of the registration process, the controlling device assumes control of programming the rendering device. An administrator is enabled to select services that can be used on the rendering device. The tuner of the rendering device is programmed according to the selections made by the administrator. The controlling device acts as an authorization agent to enable media to flow from the selected services to the rendering device.

### BACKGROUND OF THE INVENTION

1. Field of the Invention

The present invention is generally related to authentication. More particularly, the present invention is related to a method for authenticating different rendering devices with different service providers.

2. Description

Authentication of rendering devices exists today. Authentication mechanisms enable control hosts to identify, control, and access the rendering devices. The authentication mechanisms do not allow for the choosing of content that is allowed to be played on the devices. Thus, what is needed is a method for authenticating different rendering devices with different service providers and/or different servers.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a diagram illustrating an exemplary home network in which the present invention may be implemented according to an embodiment of the present invention.

FIG. 2 is a diagram illustrating the authentication of rendering devices with service providers according to an embodiment of the present invention.

FIG. 3A is a flow diagram describing an exemplary method for authenticating rendering devices with service providers according to an embodiment of the present invention.

FIG. 3B is a flow diagram describing an exemplary method for enabling a college student to access media from which a college subscribes to while on and off campus according to an embodiment of the present invention.

FIG. 4 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

Embodiments of the present invention are directed to a method for authenticating different rendering devices with different service providers and/or different servers in a home network environment. Authenticating certain devices with certain services provides control over what media one watches and/or listens to in the home. A controlling device, such as, but not limited to, a media center, a personal computer (PC), etc., within the home network acts as an authorization agent for the rendering device and the service provider. The authorization agent enables channels from different service providers to be played on different rendering devices. For example, channels 1 to 5 from service provider A may be played on rendering device 1 while channels 3 to 6 from service provider B may be played on rendering device 2. The authorization agent also enables license management for media content and billing for the license to be done in an effective manner. Thus, if content provider A wants its content to be played only on rendering device B and not on rendering device C, the authorization agent will direct the flow of media content from content provider A to rendering device B only.

Embodiments of the present invention are described as being implemented in an extended wireless PC (personal computer) home environment. An extended wireless PC home environment refers to a home network environment in which a controlling device, such as a PC, is used to extend digital media and information access throughout the home using wireless technology. Although embodiments of the invention may be described using a PC as the controlling device, one skilled in the relevant art(s) would know that other components may be used to extend digital media and information access throughout the home. Such components may include, but are not limited to, a media center, a set top box, a storage PC, or a combination thereof. One skilled in the relevant art(s) would also know that embodiments of the present invention may also be implemented in a home or a business environment that incorporate other types of computing devices to extend digital media and information access throughout the home or business using both wired and wireless technology.

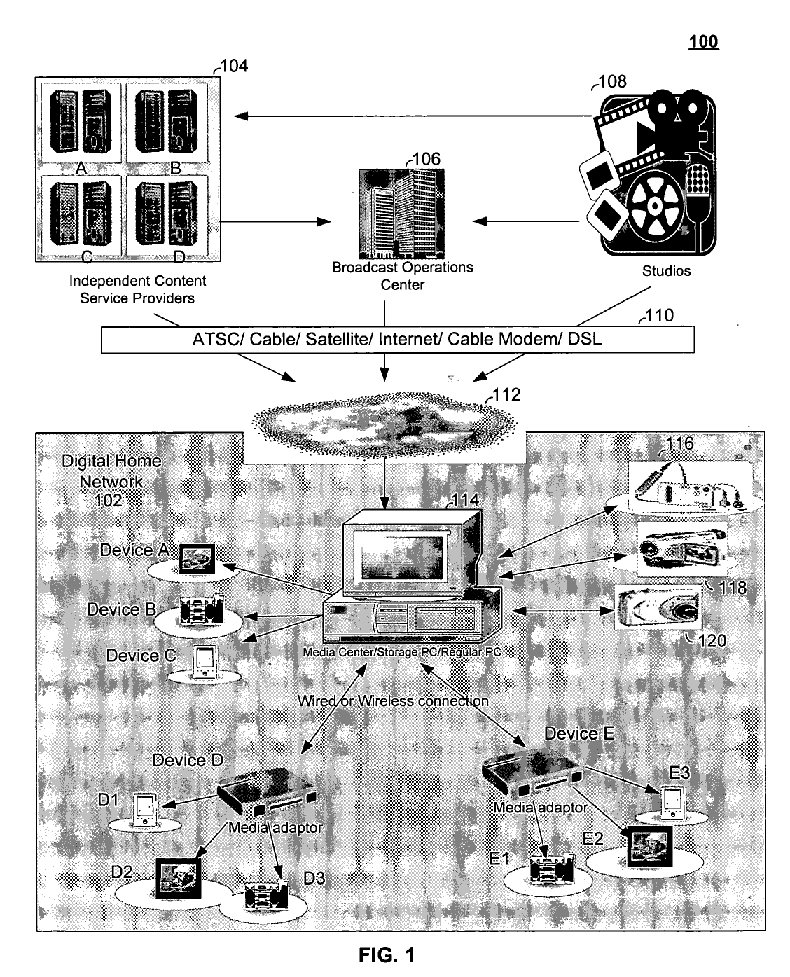

FIG. 1 is a diagram illustrating an exemplary home network system in which the present invention may be implemented according to an embodiment of the present invention. Home network system 100 may include a home network 102 that receives multimedia content over a wide area network (WAN) 112 from content providers, such as, but not limited to, independent content service providers 104 (A, B, C, and D), broadcast operations centers 106, and studios 108. In one embodiment, independent content service providers 104 and studios 108 may send their content to broadcast operations centers 106 to format the content and distribute the content to home network 102. Studios 108 may also send their content to independent content service providers 104 for formatting and distributing the content to home network 102 as well. The content may be provided to home network 102 using one or more systems 110, such as, but not limited to, a cable system using a coaxial cable connection, a satellite system using a satellite connection, an Internet service using a dial-in connection, a digital telephone connection such as DSL (Digital Subscriber Line), a high speed cable modem, etc., and an ATSC (Advanced Television Systems Committee) system using a high definition (HD) connection. The ATSC/Cable/Satellite/Internet systems 110 obtain information from independent content providers 104, broadcast operations centers 106, and studios 108 to enable audio/video information to be transferred to home network 102. Alternatively, content may be broadcast over the air to home network 102 from independent content service providers 104, broadcast operations centers 106 and studios 108.

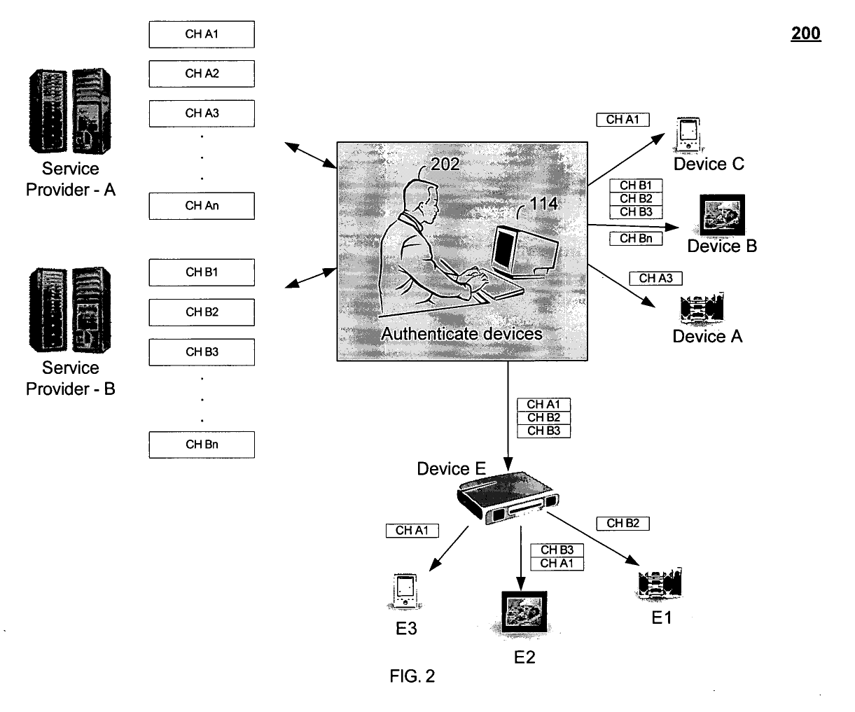

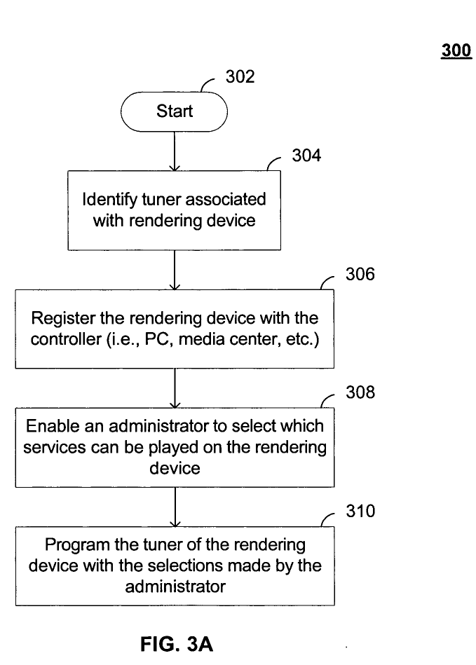

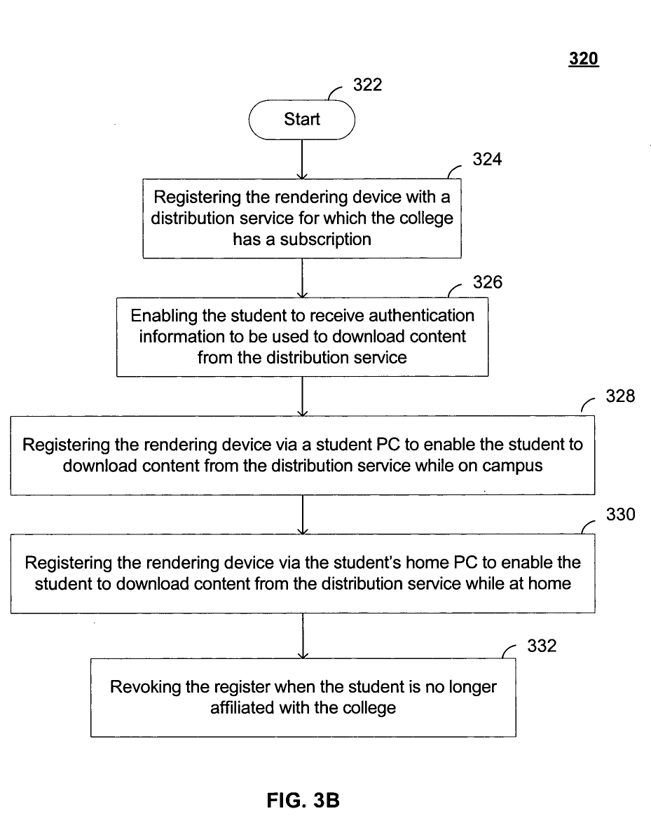

Home network 102 uses a controlling device 114 to extend digital multimedia content and information received from independent content service providers 104, broadcast operations centers 106, and studios 108 throughout the home using wired and/or wireless technology. Controlling device 114 may include, but is not limited to, a personal computer (PC), a media center, a set top box, a storage PC, a workstation, a server, a combination thereof, or any other computing device capable of storing and streaming media content. Controlling device 114 may store content distributed by independent content service providers 104, broadcast operations centers. 106, and studios 108. Controlling device 114 may distribute the content in an appropriate manner to any one or more rendering devices in the home. This will be described in detail below with reference to FIGS. 2 and 3. Home network 102 may be coupled to WAN 112 via a connection (not shown), such as, a dial-in connection, a high speed cable modem connection, a digital subscriber line (DSL) connection, a satellite connection, a HD connection, or any other means capable of connecting home network 102 to WAN 112.

Home network 102 includes a plurality of rendering devices, such as, for example, device A, device B, device C, devices D1, D2, and D3, and devices E1, E2, and E3. Devices D1, D2, and D3, and devices E1, E2, and E3 are shown in FIG. 1 as being connected to controlling device 114 via media adaptors D and E, respectively. Media adaptors D and E enable electrical connections between devices not ordinarily intended for use together. For example, media adaptor device D electrically connects controlling device 114 to rendering devices D1, D2, and D3 and media adaptor device E electrically connects controlling device 114 to rendering devices E1, E2, and E3. Rendering devices D1, D2, and D3 and E1, E2, and E3 utilize media adaptor devices D and E, respectively, in order to receive audio/video input that they would otherwise be unable to receive directly from controlling device 114. Rendering devices A, B, C, D1, D2, D3, E1, E2, and E3 may include, but are not limited to, personal digital assistants (PDA) (device C, D1, and E3), televisions (device A, D2, and E2), and stereo systems (device B, D3, and E1), all of which are well known in the relevant art(s). In one embodiment, devices A, B, and C may be located in one room of the home, devices D, D1, D2, and D3 may be located in another room of the home, while devices E, E1, E2, and E3 may be located in yet another room of the home.

In one embodiment, devices A, B, and C are shown to directly connect to controlling device 114 via a network connection. The network connection may be a wired connection, such as, for example, a DV (digital/video) connection, or it may be a wireless connection, such as, but not limited to, Bluetooth.

In one embodiment, controlling device 114 may also receive digital multimedia data from other digital devices, such as, but not limited to, an MP3 player 116, a digital camcorder 118, and a digital camera 120. The digital multimedia data received from these digital devices may be rendered on one or more of rendering devices A, B, C, D1, D2, D3, E1, E2, and E3 via controlling device 114.

In one embodiment, MP3 player 116, digital camcorder 118, and digital camera 120 may act as rendering devices and/or storage devices as well. Multimedia content from independent content service providers 104, broadcast operations centers 106, and studios 108, may be streamed to any one of devices 116, 118, and 120 for storing and/or rendering the media content.

Digital Rights Management schemes enable one to play media content on multimedia devices, such as, for example, a PC, a television, or an audio device. In home network 102, as shown above, there are many rendering devices in which media can be watched and/or listened to from controlling device 114. As previously indicated, embodiments of the present invention provide a method for authenticating different rendering devices with different service providers in a home network environment.

FIG. 2 is an exemplary diagram 200 illustrating the authentication of rendering devices with service providers according to an embodiment of the present invention. Diagram 200 includes service provider 104A, service provider 104B, controlling device 114, and rendering devices A, B, C, and E1, E2, and E3. Rendering devices A, B, and C include network connectivity that allows each of rendering devices A, B, and C to directly connect to controlling device 114. Rendering devices E1, E2, and E3 do not include network connections and, therefore, are connected to controlling device 114 via media adaptor device E.

Service provider 104A includes channels A-1, A-2, A-3, . . . , A-n. Service provider 104B includes channels B-1, B-2, B-3, . . . , B-n. The content from service providers A and B are received by controlling device 114. Controlling device 114 controls the flow of the content from the various content providers to the various rendering devices.

Controlling device 114 includes an authentication mechanism, which may be implemented in software, hardware, or a combination thereof. The authentication mechanism is aware of all content services, such as, for example, content services from content service providers 104A and 104B, that are coming into home network 102. The authentication mechanism is also simultaneously aware of rendering devices A, B, C, E1, E2, and E3 in home network 102 as well. In one embodiment, knowledge of rendering devices A, B, C, E1, E2, and E3 may be based on UPnP standards device discovery mechanisms. One skilled in the relevant art(s) would know that other discovery mechanisms may also be used to identify rendering devices A, B, C, E1, E2, and E3.

An administrator 202 of controlling device 114, such as a parent, head of the household, or another adult within the home, may decide which rendering devices, such as rendering devices A, B, C, E1, E2, and E3, can render or play content from which service providers, such as service providers 104A and 104B. For example, if rendering devices E1, E2, and E3 reside in a child's room, administrator 202 may only want the child to watch and/or listen to cartoon networks and children's channels. Administrator 202 of controlling device 114 will then configure such service using the authentication mechanism to authenticate rendering devices E1, E2, and E3 with channels from service providers 104A and 104B that provide cartoon and other children's programming. Administrator 202 does this by enabling controlling device 114 to control the programming of such channels, thereby enabling the child access via rendering devices E1, E2, and E3 to only these channels and inhibiting access to all other channels. As shown in FIG. 2, rendering device E1, which is an audio device, such as, for example, a stereo, is authenticated to receive channel. B2 from service provider 104B. Rendering device E2, which is a video/audio device, such as, for example, a television, is authenticated to receive channel A1 from service provider 104A and channel B3 from service provider 104B. And lastly, rendering device E3, which is a personal digital assistant (PDA), is authenticated to receive channel A1 from service provider 104A.

In one example, service provider 104A provides premium content on channel A3 and has a tie up with home network 102 such that service provider 104A may have special hooks in the hardware to detect rendering device C. Service provider 104A may have received special permissions from different entities to render their premium content on rendering device C in home network 102. In this instance, the authentication mechanism on controlling device 114 will allow the premium content from channel A3 on service provider 104A to be played or rendered on rendering device C. Thus, controlling device 114 authenticates rendering device C to receive the premium content from channel A3 of service provider 104A, and therefore enables the flow of content from channel A3 of service provider 104A to rendering device C only.

In another example, rendering device B has been authenticated to receive all channels from service provider 104B, while rendering device C has only been authenticated to receive channel A1 from service provider 104A. Thus, rendering device B receives content from service provider 104B only and rendering device C receives content from service provider 104A only. Both of these scenarios are also shown in FIG. 2. As shown in FIG. 2, a rendering device may be authorized to receive content from more than one service provider as well (see rendering device E2 in FIG. 2).

Standard authentication techniques, such as, for example, using identifiers (IDs), may be used to authenticate the rendering devices to controlling device 114. In one embodiment, UPnP security, which is well known to those skilled in the relevant art(s), may be used to authenticate the rendering devices to controlling device 114. In one embodiment, IDs may also be used to authenticate service providers as well.

FIG. 3A is a flow diagram 300 illustrating a method for authenticating service providers with rendering devices in a home network according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with block 302, where the process immediately proceeds to block 304.

In block 304, when a rendering device is connected to a network, such as, but not limited to, a home network, a tuner associated with the rendering device is identified. In one embodiment, the tuner may be a built in tuner that allows an external entity, such as a controlling device (i.e., controlling device 114), to control channel programming of the tuner. Yet, in another embodiment, where the rendering device may be coupled to, for example, a set top box, the set top box may include a tuner that allows the external entity to control channel programming of the tuner. The tuner includes a unique identification, stored in its hardware. In one embodiment, the unique identification may comprise the model number and serial number of the tuner or rendering device (if the tuner is included in the rendering device). In another embodiment, the unique identification may be another unique number, such as, for example, a globally unique identifier (GUID). Globally unique identifiers are well known to those skilled in the relevant art(s).

In block 306, the rendering device is registered with the controlling device via a device management application running on the controlling device. During the registration process, the controlling device stores the rendering device ID and capabilities of the rendering device, which may be obtained using UPnP discovery mechanisms. Upon completion of the registration process, the controlling device authenticates the rendering device and assumes control of programming the rendering device. From this point onward, programming of the rendering device from the rendering device's remote control or the rendering device itself is inhibited.

In block 308, an administrator is enabled to select which services can be used on the rendering device. The decision as to which services can be used on the rendering device may be influenced by many factors. Such factors may include, but are not limited to, parental restrictions as to what may be played on a child's or teenager's rendering device and licensing requirements on content that may be played on the rendering device. For example, the rendering device may be a television located in the child's room. The family may have a subscription to children's movies on demand service and may have a license restriction to watch one movie at a time from this service. The administrator (or parent in this case) may allow unlimited access of such content to flow from the service to the controlling device to the television in the child's room. At the same time, another television within the home network may also be allowed unlimited access of such content as well. The authentication mechanism within the controlling device will allow the movies on demand to be played on the television in the child's room only when a movie is not being played on the other television and vice versa. Thus, the authentication mechanism will further enforce the “one movie at a time” restriction.

In an embodiment, time restrictions on content flow may also be adhered to by the authentication mechanism. For example, a parent may have selected the display of public channels that provide cartoons and other children's content on the television in the child's room for early morning viewing, but may have restricted the viewing of the public channels during other times, such as prime time, when entertainment for adults is being played.

In block 310, once the controlling device has been programmed with the service selections from the administrator, the tuner of the rendering device is programmed via the controlling device with the selections. Once the tuner has been programmed, services that do not depend on the time of day are always enabled, and in the example for the television in the child's room, the child can change to these channels only using the remote control for the television located in the child's room. Depending on the time of day, the controlling device will automatically reprogram the rendering device to allow for time restricted programming to be played at the appropriate times. At that time, the restricted channels may be accessed from the remote control of the rendering device.

As previously indicated, the authentication of service providers with rendering devices is not limited to use within a home network. In fact, the method may be used in other networks, such as, but not limited to, for example, a network on a college campus or a network owned by a company.

FIG. 3B is an exemplary flow diagram 320 describing a method for enabling a college student to access media from which a college subscribes to while on and off campus according to an embodiment of the present invention. The invention is not limited to the embodiment described herein with respect to flow diagram 320. Rather, it will be apparent to persons skilled in the relevant art(s) after reading the teachings provided herein that other functional flow diagrams are within the scope of the invention. Although flow diagram 320 describes a method for enabling a college student to access media from which a college subscribes, embodiments of the invention are not limited to college students using college subscription services. In fact, the method may be extended to a company having a company subscription in which employees are provided media access. The process begins with block 322, where the process immediately proceeds to block 324.

In block 324, the student registers their rendering device with a distribution service, such as, but not limited to, a music distribution service or a movie distribution service for which the college has a subscription. The registration of the rendering device occurs while on campus. The registration may be done by connecting the rendering device to a secure PC, or other computing device, set up by the college for this purpose.

In block 326, at the completion of the registration process, the student receives authentication information that can be used to download content from the distribution service and play the content on the student's rendering device.

In the student's dorm room, the student may register the rendering device with PC running device management software (block 328) supplied by the college via a student PC. The student PC stores the device ID and content distribution service authentication information. Using this authentication information, the student PC can download content from the distribution service and save it on the rendering device for future playback. Only the content obtained using this particular authentication information can be played on this particular rendering device.

While the student is at home on winter or summer break, the student may register the rendering device using the PC running device management software on the student's home PC (block 330). The home PC stores the device ID and content distribution service authentication information. Using this information, the home PC can download content from the distribution service and save it on the rendering device for future playback. Only the content obtained using this particular authentication information can be played on this particular rendering device.

In block 332, when the student graduates or is no longer enrolled at the school, the registration for his/her rendering device is revoked and no more content from the distribution service used by the college can be downloaded.

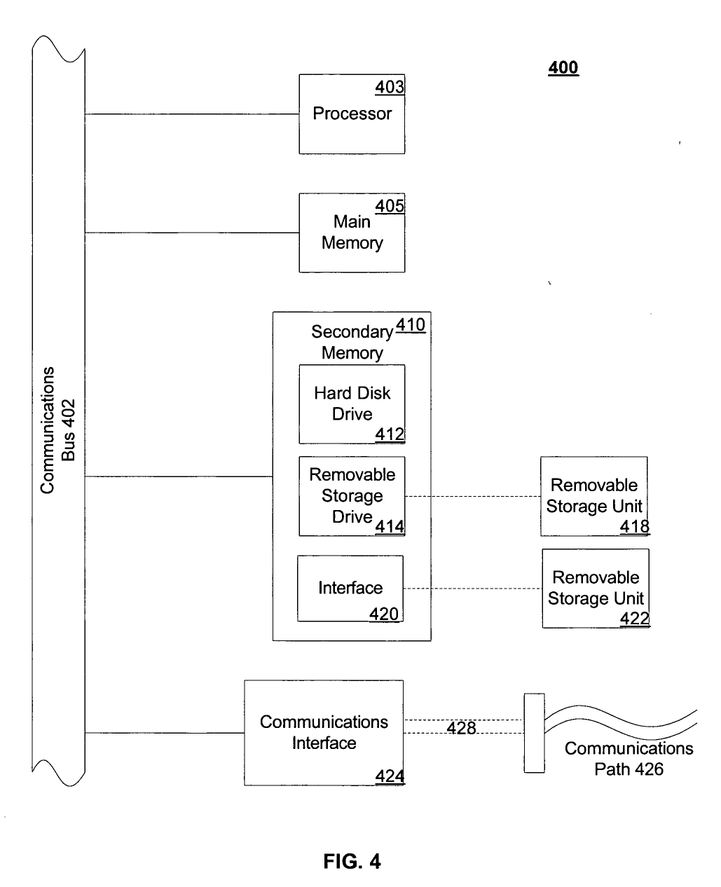

Embodiments of the present invention may be implemented using hardware, software, or a combination thereof and may be implemented in one or more computer systems or other processing systems. In fact, in one embodiment, the invention is directed toward one or more computer systems capable of carrying out the functionality described herein. An example implementation of a computer system 400 is shown in FIG. 4. Various embodiments are described in terms of this exemplary computer system 400. After reading this description, it will be apparent to a person skilled in the relevant art how to implement the invention using other computer systems and/or computer architectures.

Computer system 400 includes one or more processors, such as processor 403. Processor 403 is connected to a communication bus 402. Computer system 400 also includes a main memory 405, preferably random access memory (RAM) or a derivative thereof (such as SRAM, DRAM, etc.), and may also include a secondary memory 410. Secondary memory 410 may include, for example, a hard disk drive 412 and/or a removable storage drive 414, representing a floppy disk drive, a magnetic tape drive, an optical disk drive, etc. Removable storage drive 414 reads from and/or writes to a removable storage unit 418 in a well-known manner. Removable storage unit 418 represents a floppy disk, magnetic tape, optical disk, etc., which is read by and written to by removable storage drive 414. As will be appreciated, removable storage unit 418 includes a computer usable storage medium having stored therein computer software and/or data.

In alternative embodiments, secondary memory 410 may include other similar means for allowing computer programs or other instructions to be loaded into computer system 400. Such means may include, for example, a removable storage unit 422 and an interface 420. Examples of such may include a program cartridge and cartridge interface (such as that found in video game devices), a removable memory chip (such as an EPROM (erasable programmable read-only memory), PROM (programmable read-only memory), or FLASH memory) and associated socket, and other removable storage units 422 and interfaces 420 which allow software and data to be transferred from removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a PCMCIA (personal computer memory card international association) slot and card, a wireless LAN (local area network) interface, etc. Software and data transferred via communications interface 424 are in the form of signals 428 which may be electronic, electromagnetic, optical or any other signals capable of being received by communications interface 424. These signals 428 are provided to communications interface 424 via a communications path (i.e., channel) 426. Channel 426 carries signals 428 and may be implemented using wire or cable, fiber optics, a phone line, a cellular phone link, a wireless link, and other communications channels.

In this document, the term “computer program product” refers to removable storage units 418, 422, and signals 428. These computer program products are means for providing software to computer system 400. Embodiments of the invention are directed to such computer program products.

Computer programs (also called computer control logic) are stored in main memory 405, and/or secondary memory 410 and/or in computer program products. Computer programs may also be received via communications interface 424. Such computer programs, when executed, enable computer system 400 to perform the features of the present invention as discussed herein. In particular, the computer programs, when executed, enable processor 403 to perform the features of embodiments of the present invention. Accordingly, such computer programs represent controllers of computer system 400.

In an embodiment where the invention is implemented using software, the software may be stored in a computer program product and loaded into computer system 400 using removable storage drive 414, hard drive 412 or communications interface 424. The control logic (software), when executed by processor 403, causes processor 403 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. An authentication method comprising:
identifying, by a controlling device, a tuner associated with a rendering device, wherein the tuner includes a unique identification;
registering the rendering device with the controlling device, wherein upon completion of the registration process, the controlling device assumes control of programming the rendering device;
enabling an administrator to select services that can be used on the rendering device; and
programming the tuner of the rendering device according to the selections made by the administrator, wherein the controlling device acts as an authorization agent to enable media to flow from the selected services to the rendering device.

2. The method of claim 1, wherein a user of the rendering device can only play media from the selected services identified by the administrator using a remote control for the rendering device.

3. The method of claim 1, wherein the controlling device comprises at least one of a personal computer, a set top box, a combination personal computer and set top box, a workstation, and a media center.

4. The method of claim 1, wherein registering the rendering device with the controlling device includes storing the rendering device identification and storing capabilities of the rendering device.

5. The method of claim 4, wherein capabilities of the rendering device are identified using device discovery methods.

6. The method of claim 1, wherein registering the rendering device with the controlling device includes authenticating the rendering device with the controlling device.

7. The method of claim 1, wherein enabling an administrator to select services that can be used on the rendering device comprises:
determining whether there are restrictions based on the user of the rendering device;
determining whether there are restrictions imposed by service providers providing the services;
determining whether there are licensing requirements on the content being provided by the service providers; and
enabling the selection of the services according to the restrictions on the user, restrictions imposed by the service providers, and the licensing requirements.

8. The method of claim 7, wherein restrictions based on the user include time of day restrictions, and wherein services that do not depend on the time of day are always enabled, and wherein services that do depend on the time of day are enabled at times specified by the administrator.

9. The method of claim 1, further comprising reprogramming the tuner of the rendering device at predetermined time intervals to accommodate time of day programming restrictions on services.

10. The method of claim 9, wherein time of day programming restrictions are enabled and disabled, respectively, during the predetermined time intervals.

11. The method of claim 1, wherein when the controlling device is enabled for programming the rendering device, programming of the rendering device is disabled using one of a remote control for the rendering device and the rendering device itself.

12. A network authentication method comprising:
registering a rendering device with a distribution service for which an organization has a subscription, wherein upon completion of registering the rendering device, a user of the rendering device receives distribution service authentication information to be used to download media content from the distribution service; and
enabling the user to register the rendering device using device management software supplied by the organization on a first computer, wherein the first computer is located within the organization and operated by the user;
wherein the first computer stores an identification for the rendering device and the distribution service authentication information, wherein using the distribution service authentication information enables the user to download content from the distribution service and save the content on the rendering device for future playback.

13. The method of claim 12, wherein registering a rendering device with a distribution service for which an organization has a subscription includes connecting the rendering device to a secure computing device used by the organization for the purpose of registering the rendering device.

14. The method of claim 12, further comprising enabling the user to register the rendering device using device management software supplied by the organization on a second computer, wherein the second computer resides in a location other than the organization, wherein the second computer stores the identification for the rendering device and the distribution service authentication information, wherein using the distribution service authentication information enables the user to download content from the distribution service via the second computer and save the content on the rendering device for future playback.

15. The method of claim 12, wherein the registration for the rendering device is revoked when the user is no longer affiliated with the organization.

16. The method of claim 15, wherein no more content from the distribution service used by the organization can be downloaded when the registration for the rendering device is revoked.

17. An article comprising: a storage medium having a plurality of machine accessible instructions, wherein when the instructions are executed by a processor, the instructions provide for identifying, by a controlling device, a tuner associated with a rendering device, wherein the tuner includes a unique identification;
registering the rendering device with the controlling device, wherein upon completion of the registration process, the controlling device assumes control of programming the rendering device;
enabling an administrator to select services that can be used on the rendering device; and
programming the tuner of the rendering device according to the selections made by the administrator, wherein the controlling device acts as an authorization agent to enable media to flow from the selected services to the rendering device.

18. The article of claim 17, wherein a user of the rendering device can only play media from the selected services identified by the administrator using a remote control for the rendering device.

19. The article of claim 17, wherein the controlling device comprises at least one of a personal computer, a set top box, a combination personal computer and set top box, a workstation, and a media center.

20. The article of claim 17, wherein instructions for registering the rendering device with the controlling device includes instructions for storing the rendering device identification and storing capabilities of the rendering device.

21. The article of claim 20, wherein capabilities of the rendering device are identified using device discovery methods.

22. The article of claim 17, wherein instructions for registering the rendering device with the controlling device includes instructions for authenticating the rendering device with the controlling device.

23. The article of claim 17, wherein instructions for enabling an administrator to select services that can be used on the rendering device comprises instructions for:
determining whether there are restrictions based on the user of the rendering device;
determining whether there are restrictions imposed by service providers providing the services;
determining whether there are licensing requirements on the content being provided by the service providers; and
enabling the selection of the services according to the restrictions on the user, restrictions imposed by the service providers, and the licensing requirements.

24. The article of claim 23, wherein restrictions based on the user include time of day restrictions, and wherein services that do not depend on the time of day are always enabled, and wherein services that do depend on the time of day are enabled at times specified by the administrator.

25. The article of claim 17, further comprising instructions for reprogramming the tuner of the rendering device at predetermined time intervals to accommodate time of day programming restrictions on services.

26. The article of claim 25, wherein time of day programming restrictions are enabled and disabled, respectively, during the predetermined time intervals.

27. The article of claim 17, wherein when the controlling device is enabled for programming the rendering device, programming of the rendering device is disabled using one of a remote control for the rendering device and the rendering device itself.

28. An article comprising: a storage medium having a plurality of machine accessible instructions, wherein when the instructions are executed by a processor, the instructions provide for registering a rendering device with a distribution service for which an organization has a subscription, wherein upon completion of registering the rendering device, a user of the rendering device receives distribution service authentication information to be used to download media content from the distribution service; and
enabling the user to register the rendering device using device management software supplied by the organization on a first computer, wherein the first computer is located within the organization and operated by the user;
wherein the first computer stores an identification for the rendering device and the distribution service authentication information, wherein using the distribution service authentication information enables the user to download content from the distribution service and save the content on the rendering device for future playback.

29. The article of claim 28, wherein instructions for registering a rendering device with a distribution service for which an organization has a subscription includes instructions for connecting the rendering device to a secure computing device used by the organization for the purpose of registering the rendering device.

30. The article of claim 28, further comprising instructions for enabling the user to register the rendering device using device management software supplied by the organization on a second computer, wherein the second computer resides in a location other than the organization, wherein the second computer stores the identification for the rendering device and the distribution service authentication information, wherein using the distribution service authentication information enables the user to download content from the distribution service via the second computer and save the content on the rendering device for future playback.

31. The article of claim 28, wherein the registration for the rendering device is revoked when the user is no longer affiliated with the organization.

32. The article of claim 31, wherein no more content from the distribution service used by the organization can be downloaded when the registration for the rendering device is revoked.

33. A network system comprising:
a plurality of rendering devices, wherein the plurality of rendering devices are located within rooms throughout a building;
a controller, coupled to each of the plurality of rendering devices, to control the flow of digital media received from a plurality of content service providers to the plurality of rendering devices, wherein the controller comprises an authentication mechanism to authenticate different service providers with different rendering devices.

34. The network system of claim 33, wherein an administrator of the controller determines which rendering devices can render content from which service providers, configures the channels from the service providers for rendering the channels on the rendering devices, and enables authentication of the rendering devices with the service providers who provide the channels.

35. The network system of claim 33, wherein the controller comprises at least one of a media center, a set top box, a personal computer, a combination set top box and personal computer, and a workstation.

36. The network system of claim 33, wherein the controller authenticates at least one rendering device to access content from at least one service provider.

37. The network system of claim 36, wherein content from at least one service provider includes selected channels from at least one service provider.

38. The network system of claim 33, wherein the controller authenticates at least one rendering device to access content from a plurality of service providers.

39. The network system of claim 38, wherein content from a plurality of service providers includes selected channels from each of the plurality of service providers.
